(19) United States
(12) Patent Application Publication
(10) Pub. No.: US 2015/0015645 A1
(43) Pub. Date: Jan. 15, 2015

(54) DEGASSING APPARATUS AND METHODS THEREOF

(71) Applicant: Loc V. Bui, Moorpark, CA (US)

(72) Inventor: Loc V. Bui, Moorpark, CA (US)

(21) Appl. No.: 13/940,138

(22) Filed: Jul. 11, 2013

(51) Int. Cl. B41J 2/19

(52) U.S. Cl. CPC B41J 2/19
USPC 347/92

(57) ABSTRACT

A degassing apparatus for a liquid delivery system is provided. The degassing apparatus includes a first chamber disposed along a liquid delivery path to capture gas within the liquid delivery path. The degassing apparatus also includes a set of membranes having at least one membrane, the set of membranes disposed along the liquid delivery path to selectively allow the gas to pass through the set of membranes. The degassing apparatus further includes a second chamber disposed above the set of membranes to evacuate the gas from the first chamber. Moreover, the degassing apparatus includes a one-way valve configured to vent the gas from the second chamber when pressure inside the second chamber exceeds a first predetermined value.

### BACKGROUND OF THE INVENTION

Industrial printing typically requires heavy usage of ink. However, the small amount of ink stored in a conventional ink cartridge makes the conventional ink cartridge impractical in heavy duty printing. As an attempt to provide an economical solution, conventional ink cartridge has been modified to support additional ink being fed from an external source. As a result, a bulk ink supply (BIS) system has been developed to meet the industrial printing's need without requiring major configuration design change to the current conventional ink cartridge.

To facilitate discussion, FIG. 1 shows a simple block diagram of a bulk ink supply (BIS) system 100. BIS system 100 includes an ink cartridge 102 and a bulk ink source 112. Bulk ink source 112 is connected to ink cartridge 102 through a set of connectors (106 and 116). Once the connectors are interlocked, a closed and balanced environment is created. Furthermore, bulk ink source 112 is placed at an optimized position (usually below ink cartridge 102) to create a negative pressure within the closed and balanced environment, thereby creating a back pressure that prevents ink from leaking out of ink cartridge 102 via a nozzle plate 104. For example, in a BIS system in which the ink cartridge is capable of storing 42 ml of ink and the bulk ink source is capable of storing 370 ml of ink, the bulk ink source may be positioned about 45 mm below the ink cartridge to prevent the ink from leaking out of the nozzle plate.

During the printing operation, the ink is ejected out of ink cartridge 102 through nozzle plate 104. Specifically, during a thermal printing process, heat is utilized to rapidly vaporize the ink and to create micro-bubbles at very high speed. For example, nozzle plate 104 may have up to 300 nozzles. Each nozzle may have a miniature heater (resistor) that creates nucleation of the ink by heating up the ink at a very high rate (about 12 kilohertz/second). The micro-bubbles that are created during nucleation may coalesce to create a bigger bubble. As the bubble expands, the ink is pushed out through volume displacement. In a conventional ink cartridge, each nozzle is capable of generating at least 12,000 drops of ink per second. Once the ink is pushed out, the bubble collapses and gas (such as air) is released from the bubble. The gas is then absorbed hack into ink cartridge 102 while ink is refilled toward nozzle plate 104. In a conventional ink cartridge, the gas that is absorbed back into the ink cartridge usually does not have a significant negative impact on the ink flow given that the geometry of the ink cartridge has been designed to handle the amount of gas that is generated during printing of 42 ml of ink.

As can be appreciated from the foregoing, the usage of conventional ink cartridges in industrial printing is impractical given the heavy demand for ink. Thus, attempts to meet industrial printing's demand have given rise to the creation of the BIS system. In the BIS system, the conventional ink cartridge is coupled with a bulk ink source. In other words, the conventional ink cartridge is now servicing not only the original amount of ink stored within itself but is also now attempting to handle the additional large load of ink coming from the bulk ink source. In an example, a conventional ink cartridge may be configured to handle 42 ml of ink. However, a bulk ink source may introduce an additional 800-900 percent more ink.

Given the large additional amount of ink being channeled through ink cartridge 102, the amount of gas being generated and pushed back into the ink cartridge usually becomes more than the BIS system can handle. For example, ink may flow from bulk ink source 112 through a tube 108 to ink cartridge 102. During the printing process, the gas that is generated when the ink is pushed out may flow back into ink cartridge 102. As the gas is absorbed back into the ink cartridge, the gas may float back along the ink channel toward the highest point in the channel (point 110). As the gas accumulates at highest point 110, the accumulated gas may create a condition known as vapor lock. As discussed herein, vapor lock refers to the condition in which gas accumulates and coalesces to prevent the flow of liquid (such as ink). In other words, as the gas expands and accumulates, the gas blocks the ink channel and prevents the ink from flowing from bulk ink source 112 through tube 108 into ink cartridge 102 and out of nozzle plate 104.

Even though ink is no longer reaching nozzle plate 104, the miniature heaters near the nozzle plate continue to run since ink cartridge 102 is unaware of the vapor lock condition. As the vapor lock condition persists, the continual heating of the dry resistors near nozzle plate may cause nozzle plate 104 to bum and be destroyed. Unfortunately, once the resistors near nozzle plate 104 are destroyed, BIS system 100 is no longer usable. The cost saving associated with BIS system is usually not realized given that the vapor lock condition usually occurs before the entire in supply in a BIS system may be consumed. Typically, only about ⅓ of the ink from the bulk ink source is consumed before the vapor lock condition transpires. As a result, the cost saving associated with the BIS system is usually not fully realized.

In order to prevent vapor lock, different methods and apparatuses have been implemented in an attempt to degas the closed and balanced BIS system. For example, pressure reduction through vacuum degasification may be employed to reduce pressure in the enclosed system. Unfortunately, this method is not only expensive but can also result in altering the composition of the liquid. Another method includes increasing the temperature within the enclosed system. This method may reduce the amount of gas being produced; however, increasing the temperature can unintentionally change the composition of the liquid.

Another method for degasification includes the usage of membrane. FIG. 2 shows an example of degasification through the usage of an active vacuum membrane degassing system. The active vacuum membrane degassing system may include a membrane degassing cartridge 200 that may be attached to an external vacuum pumping system (not shown).

Membrane degassing cartridge 200 may be retrofitted into the BIS system by coupling the tube to an ink inlet 202. Once retrofitted, ink may flow from the bulk ink source through membrane degassing cartridge 200 to the ink cartridge. Membrane degassing cartridge 200 may also include a membrane 204 for degassing the ink. Ink may flow through ink inlet 202 at a point 202a. As the ink flows into membrane degassing cartridge 200 through a distribution channel 206a, a baffle 208 may be employed to prevent the ink from flowing straight through. Instead the ink may flow radially outward through a set of hollow fibers (210) across the surface area of membrane 204 toward the outside surface of membrane 204. Since the height of baffle 208 is slightly less than membrane 204, once the ink flows along the outside surface of membrane 204, the ink can flow pass baffle 208 to cross over to the opposite side. The ink may then flow through the set of hollow fibers (210) to a collection channel 206b and out of ink outlet 212 along a path 212b toward the ink cartridge.

As the ink flows across the surface area of membrane 204, degassing may occur as the gas inherent in the ink is separated and removed from the ink. A negative pressure is created through an external vacuum system (not shown) that is connected to the membrane degasification cartridge at a vacuum inlet 222. In an example, as the ink travels through the set of hollow fibers 210. the gas is separated from the ink and removed through vacuum outlet 222 along a path 218.

Although the active vacuum membrane degassing system may provide for degasification, the active vacuum membrane degassing system still does not solve the vapor lock condition. As can be seen from FIG. 2, membrane degassing cartridge may only degas the gas flowing in the same direction as the liquid (such as the gas inherent in the liquid). In other words, the membrane degassing cartridge is not designed for removing the gas that is counter-flowing to the ink (i.e., the gas that is being pushed back into the ink cartridge during the printing process).

In addition, the active vacuum membrane degassing system is expensive. For example, the cost of a membrane degassing cartridge with the active vacuum system can add several hundred dollars to the cost of a BIS system. Further, the requirement to retrofit the membrane degassing cartridge into the BIS system requires skill and knowledge that a typical user may not possess. Also, the closed and balanced BIS system that is required to maintain the negative back pressure may be disrupted during retrofitting as the BIS system become exposed to the external environment. Further, the external vacuum system that is employed to remove the gas may change the passive BIS system into an active system. Thus, the membrane degassing cartridge with the active vacuum system not only does not solve the vapor lock condition but may also eliminate the cost saving associated with the BIS system.

As a result, an inexpensive degassing apparatus and methods are desired that prevent vapor lock while minimizing the impact to the closed and balanced BIS system.

### BRIEF SUMMARY OF THE INVENTION

The invention relates, in an embodiment, to a degassing apparatus for a liquid delivery system. The degassing apparatus includes a first chamber disposed along a liquid delivery path to capture gas within the liquid delivery path. The degassing apparatus also includes a set of membranes having at least one membrane, the set of membranes disposed along the liquid delivery path to selectively allow the gas to pass through the set of membranes. The degassing apparatus further includes a second chamber disposed above the set of membranes to evacuate the gas from the first chamber. Moreover, the degassing apparatus includes a one-way valve configured to vent the gas from the second chamber when pressure inside the second chamber exceeds a first predetermined value.

The invention also, in an embodiment, relates to a liquid delivery system. The liquid delivery system includes a liquid source and a liquid recipient. The liquid delivery systems also includes a set of liquid distribution channels having at least one liquid distribution channel for moving liquid between the liquid source and the liquid recipient. The liquid delivery system further includes a degassing module disposed along the at least one liquid distribution channel of the set of liquid distribution channels. The degassing module includes a first chamber disposed along a liquid delivery path of the at least one liquid distribution channel to capture gas within the liquid delivery path. The degassing module also includes a set of membranes having at least one membrane. The set of membranes is disposed along the liquid delivery path to selectively allow the gas to pass through the set of membranes. The degassing module further includes a second chamber disposed above the set of membranes to evacuate the gas from the first chamber. Moreover, the degassing module includes a one-way valve configured to vent the gas from the second chamber when pressure inside the second chamber exceeds a first predetermined value.

The invention further, in an embodiment, relates to a method for degassing in a liquid delivery system. The method includes providing a first chamber disposed along a liquid delivery path of the liquid delivery system to capture gas from the liquid delivery system. The method also includes providing a second chamber, the second chamber being disposed above the first chamber and separated from the first chamber by a set of membranes having at least one membrane that is selectively permeable with respect to the gas and selectively impermeable with respect to liquid of the liquid delivery system. The method further includes providing a one-way valve with the second chamber such that the one-way valve opens to vent the gas from the second chamber when pressure within the second chamber exceeds a first pre-determined value.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 shows a simple block diagram of a bulk ink supply (BIS) system.

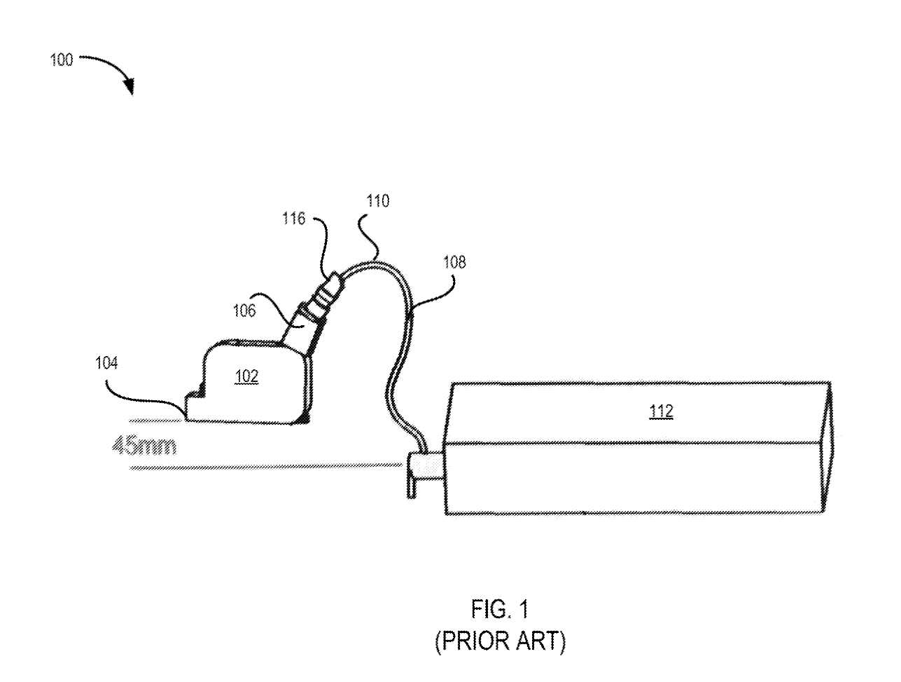

FIG. 2 shows an example of an active vacuum membrane degassing system.

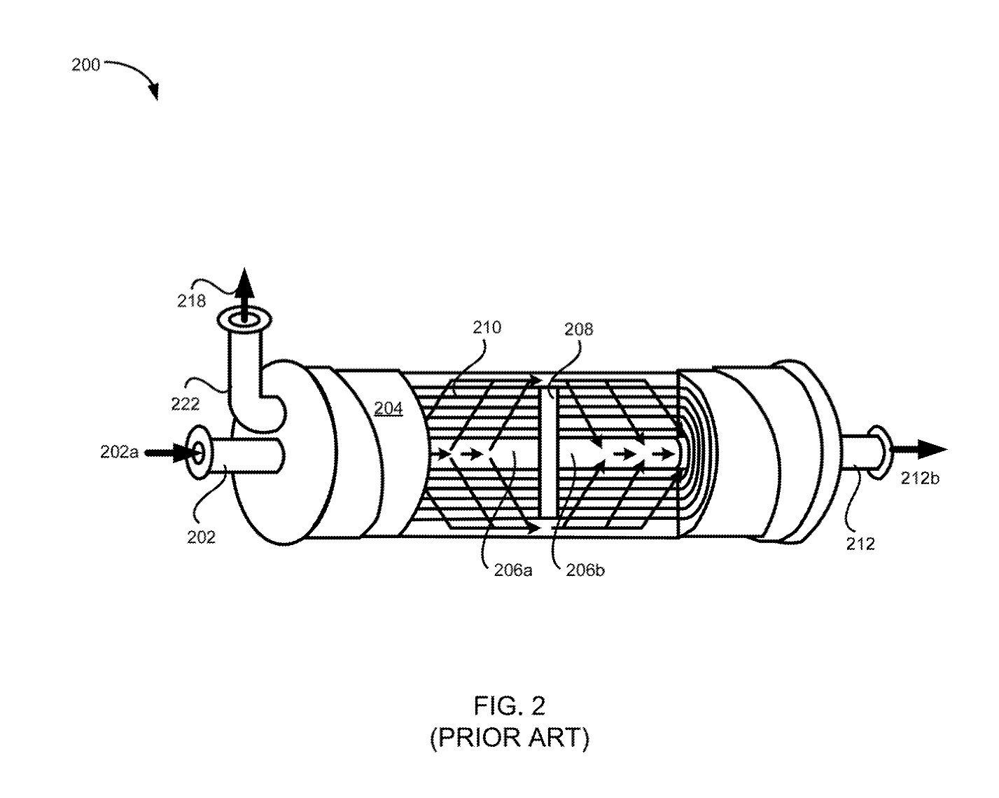

FIG. 3A shows, in an embodiment of the invention, a simple diagram of a degassing module.

FIG. 3B shows, in an embodiment, a more detailed illustration of the main components of a degassing module.

FIG. 4 shows, in an embodiment an example of an implementation of a degassing module.

FIG. 5 shows, in an embodiment of the invention, a simple flow chart illustrating the method for providing a passive degassing module.

FIG. 6 shows, in an embodiment of the invention, a simple flow chart illustrating the method for implementing a passive degassing module within a liquid delivery system.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

The invention is described with reference to specific architectures and protocols. Those skilled in the art will recognize that the description is for illustration and to provide examples of different mode of practicing the invention. The description is not meant to be limiting. For example, reference is made to a bulk ink supply system, while other liquid delivery system may be utilized with the invention.

In accordance with embodiments of the present invention, arrangements and methods are provided for automatically degassing a closed and balanced liquid delivery system. Embodiments of the invention include a degassing module configured for evacuating gas from the liquid delivery system. Embodiments of the invention also provide for methods for automatically performing degassing in a non-invasive manner.

In an embodiment of the invention, a degassing module is provided for removing gas from a liquid delivery system. As discussed herein, gas includes but is not limited to oxygen, nitrogen, carbon monoxide, carbon dioxide, hydrogen, fluoride, chlorine, and the like. As discussed herein, a liquid delivery system refers to a system in which liquid is delivered from a liquid source to a liquid recipient.

In an embodiment, the degassing module includes a first chamber disposed along a liquid delivery path, wherein the liquid delivery path is between the liquid source and the liquid recipient. As liquid flows between the liquid source and the liquid recipient, gas may accumulate in the first chamber of the degassing module. In an embodiment, the gas collected may be flowing in the direction of the liquid flow and/or in the counter direction.

In one aspect of the invention, the inventor realizes that the point of vapor lock may be employed to spontaneously accumulate gas and a membrane may be employed to selectively evacuate gas from a closed and balance liquid delivery system. Those skilled in the art are aware that gas is lighter than liquid and tends to rise to the top. By positioning a gas permeable membrane at the highest point of the liquid delivery system (the position at which gas rises to), the gas permeable membrane is positioned to remove the gas as the gas accumulates from the closed, and balanced liquid delivery system.

A set of membranes may be disposed above the first chamber, in an embodiment. As discussed herein, the term ‘above’ denotes a position that is higher relative to the direction of gravity. For example, the set of membranes is disposed at a position higher relative to the direction of gravity in relation to the first chamber. In addition, the term ‘above’ may refer to a position directly above or at an angle. Analogously, the term ‘below’ denotes a position lower relative to the direction of gravity. In addition, the term ‘below’ may refer to a position directly below or at an angle. For example, the first chamber is disposed at a position lower relative to the direction of gravity in relation to the set of membranes.

In an embodiment, the set of membranes may be a single gas permeable membrane that selectively allows gas to flow through without allowing liquid to pass through. In an embodiment, the membrane is made from a material that is inert thereby minimizing any potential change to the composition of the gas and/or liquid. Gas permeable membrane may be made from Teflon®, silicone and other gas permeable material.

In an embodiment of the invention, the gas may pass through the membrane into a second chamber. The second chamber may act as a “waiting room” and provide for an alternative location for temporarily storing the gas, thereby preventing the gas from blocking the distribution channel and creating the vapor lock condition. In an embodiment, a one-way valve may be positioned above the second chamber. The one-way valve may automatically open when the pressure within the second chamber reaches a predetermined maximum level. When the valve is in an opened position, the gas is evacuated from the second chamber. Once the pressure within the second chamber reaches a predetermined minimal level, the one-way valve may automatically close, thereby preventing gas from the external environment to flow inward, thereby maintaining the closed, and balanced environment within the BIS system.

The features and advantages of the present invention may be better understood with reference to the figures and discussions that follow.

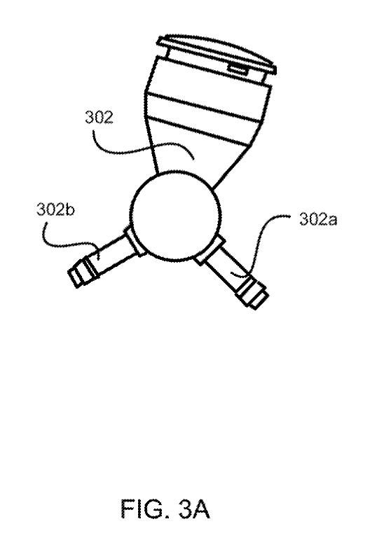

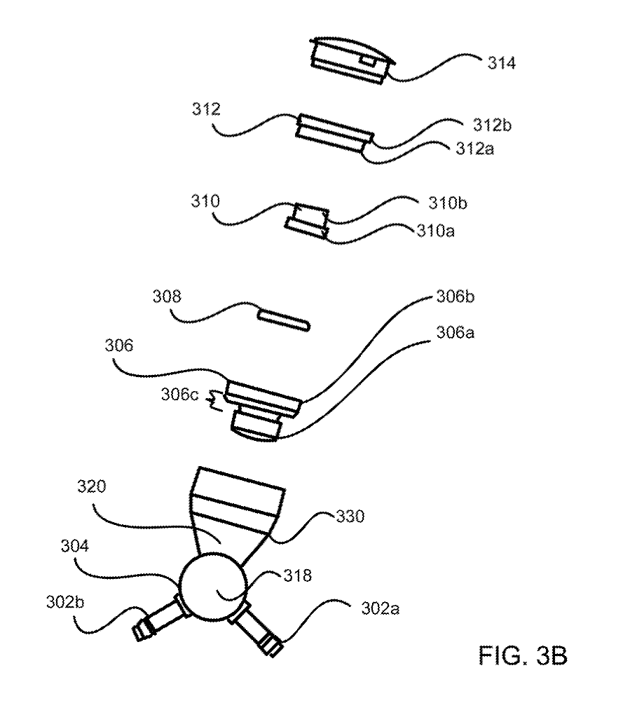

FIG. 3A shows, in an embodiment of the invention, a simple diagram of a degassing module 302. Degassing module 302 is relatively small in comparison to the BIS system with a dimension that is usually about 100 times smaller in volume to the BIS system and can be attached between a liquid source (e.g., bulk ink source) and a liquid recipient (e.g., ink cartridge).

FIG. 3B shows, in an embodiment, a more detailed illustration of the main components of degassing module 302. Degassing module 302 may include a housing 304. Inserted into housing 304 may be a base housing 306. Once inserted, base housing 306 may fit snugly at position 330 of housing 304 to form a liquid and air-tight seal.

Base housing 306 may include a membrane 310. In an embodiment, membrane 310 may be permeable to gas but impermeable to liquid (such as ink). In an embodiment, membrane 310 may be made from Teflon® or silicone. Membrane 310 may be pressed fit into base housing 306 or retained in position relative to base housing 306 by other conventional attachment techniques. Once inserted into base housing 306, part 310b of membrane 310 may rest at position 306a of base housing 306 with part 310a of membrane 310 extending from base housing, 306.

Base housing 306 may also include a valve 312. In an embodiment, valve 312 may be a one-way valve. In other words, valve 312 enables air to be vented but prevents air from flowing inward. Valve 312 may be pressed fit into base housing 306 or retained in position relative to base housing 306 by other conventional attachment techniques. Once inserted, part 312a of valve 312 may rest at position 306b with part 312b extending upward.

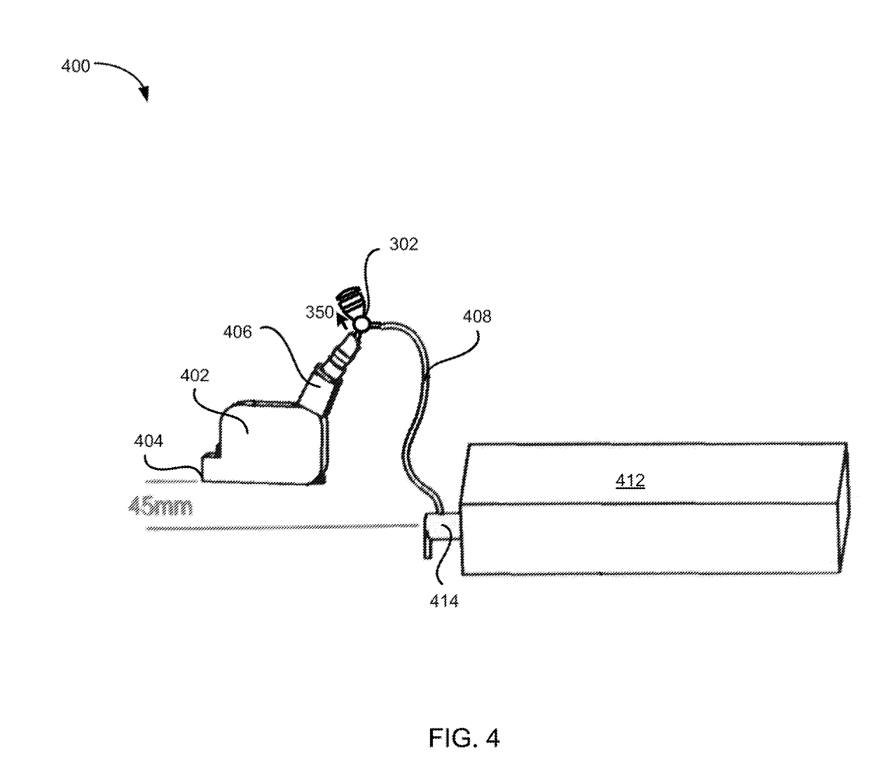

In an embodiment, degassing module 302 is a passive degasification system that requires no external forces to prevent vapor lock. To facilitate discussion, FIG. 4 shows, in an embodiment an example of an implementation of a degassing module.

Consider the situation of a liquid delivery system such as a bulk ink supply (BIS) system 400. BIS system may include a bulk ink source 412. Liquid such as ink may flow from bulk in source 412 through a distribution channel 408 (e.g., tube) to an ink cartridge 402. In an embodiment, distribution channel 408 may be one or more channels. To prevent the liquid (e.g., ink) from oozing out from a nozzle plate 404, the center of an ink feed 414 of bulk ink source 412 may be positioned at an optimal distance to create a negative head (negative pressure). For example, in a BIS system in which the ink cartridge is capable of storing 42 ml of ink and the bulk ink source is capable of storing 370 ml of ink, the optimal distance is about 45 mm between nozzle plate 404 and a center of an ink feed 414 of bulk ink source 412.

In an embodiment, degassing module 302 may be positioned along a distribution channel 408 between bulk ink source 412 and ink cartridge 402. In one embodiment, an ink inlet 302a (as shown in FIG. 3B) may be coupled to distribution channel 408 and an ink outlet 302b (as shown in FIG. 3A) may be coupled to ink cartridge 402 via a set of connectors 406 or via a tubing section and set of connectors 406. In an embodiment, distribution channel 408 may include, but is not limited to polyethylene tubing and/or polyurethane tubing. Given that gas (e.g., oxygen, nitrogen, carbon monoxide, carbon dioxide, hydrogen, fluoride and other gases) tends to rise, degassing module 302, in an embodiment, may be positioned at the highest point relative to ink cartridge 402, thereby enabling gas to spontaneously accumulate at degassing module 302. As discussed herein, the highest point refers to a position within a close system in which gas tends to rise upward to. Thus, the highest point may vary depending upon the system. In an embodiment, the liquid delivery system is mounted on a bracket (not shown) to secure the system in place and to ensure that the degassing module is positioned at the highest point.

During the printing process, ink is ejected out of ink cartridge 402 via nozzle plate 404, which may include a plurality of nozzles (e.g., 300 nozzles or more). As the resistor (e.g., miniature heater) heats up, nucleation may occur causing the ink to be pushed out through volume displacement. The gas that is generated during the nucleation process is pushed back into ink cartridge 402. Given that gas tends to rise to the highest point, the gas that is released during the printing process may travel back through ink cartridge 402 back through ink outlet 302b and may accumulate at a passage 318 (bottom portion of a first chamber 320 within housing 304) of degassing module 302. Besides the gas that is flowing in a counter-flow direction to the ink, ink from bulk ink source 412 and the gas inherent in the ink may also accumulate at passage 318. In an embodiment, passage 318 is configured to be larger in dimension in comparison to inlet 302a and/or outlet 302b. Unlike the prior art, gas may accumulate in passage 318 without hindering the liquid flow from ink inlet 302a to ink outlet 302b, therefore preventing vapor lock from occurring. In an embodiment, the ink and the gas may also accumulate and flow upward (in the direction of an arrow 350) toward membrane 310. In an embodiment, a sealing member or sealing material (such as an o-ring 308, as shown in FIG. 3B) may be employed below membrane 310 to prevent the liquid (e.g., ink) from flowing in the direction of arrow 350 to the edge of membrane 310.

In an embodiment, membrane 310 is a selective membrane that is permeable to gas. For example, even though the liquid may completely fill first chamber 320, membrane 310 may prevent the liquid from flowing upward (in the direction of arrow 350). Instead only gas is able to permeate though membrane 310. Once the gas flows through membrane 310, the gas may accumulate in a second chamber 306c that is positioned between membrane 310 and valve 312. As gas accumulates in second chamber 306c, the pressure within the second chamber may increase. Once the pressure reaches a first predetermined value (predetermined maximum level), valve 312 may automatically open and release the gas to the external environment through a vented cover 314. In an embodiment, the first predetermined value may be at least 20 mm of H₂O and be as high as 70 mm of H₂O depending upon the dimension of the valve. As can be appreciated, the pressure within the second chamber prevents gas from the external environment from entering the second chamber while valve 312 is opened. After gas is vented, the pressure within second chamber 306c is reduced. Once the pressure within the second chamber reaches a second predetermined value (predetermined minimum level), valve 312 may automatically close, thereby preventing external gas from flowing back into the second chamber. In an embodiment, the second predetermined value may be between 5 to 45 mm of H) depending upon the dimension of the valve.

As can be appreciated from the foregoing, the degassing module may he implemented within any liquid delivery system. In an example, the degassing module may be employed within the medical field. For example, bulk ink source 412 may be any liquid source such as an IV bag (within the medical field). Distribution channel 408 may be a tube that delivers the saline solution. Ink cartridge 402 may be any recipient of the liquid source, including a human in the IV bag example. In the IV hag example, the degassing module prevents vapor lock from occurring, thereby enabling the saline solution to be delivered to the recipient.

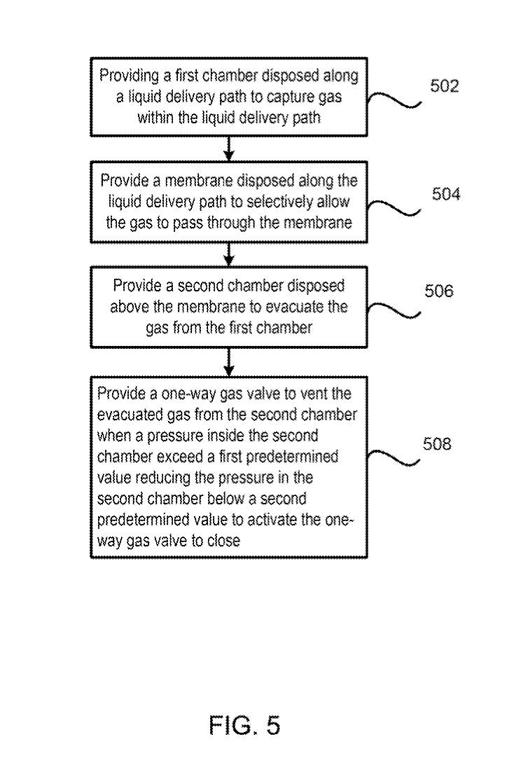

FIG. 5 shows, in an embodiment of the invention, a simple flow chart illustrating the method for providing a passive degassing module.

At a first step 502, a first chamber is disposed along a liquid delivery path for gas to accumulate within the liquid delivery system. In an embodiment, the gas collected in the first chamber may be gas inherent within the liquid source (the gas that is flowing in the same direction of the liquid). In addition, the gas collected may also be generated during nucleation (the gas flowing in the counter-flow direction of the liquid).

At a next step 504, a membrane is disposed along the liquid delivery path to selectively allow the gas to pass through the membrane.

At a next step 506, a second chamber is disposed above the membrane to evacuate the gas from the first chamber. As previously mentioned, the term ‘above’ denotes it position that is higher relative to the direction of gravity and may refer to a position directly above or at an angle.

At a next step 508, a one-way gas valve is provided to vent the evacuated gas from the second chamber when the pressure within the second chamber exceeds a first predetermined value (predetermined maximum level). As the gas is vented, the pressure is reduced. Once the pressure reaches a second predetermined value (predetermined minimal level), the one-way gas valve is closed.

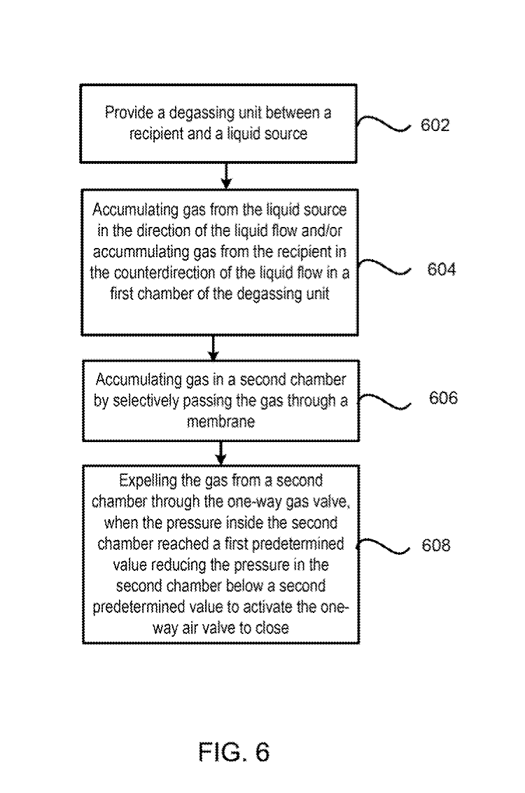

FIG. 6 shows, in an embodiment of the invention, a simple flow chart illustrating the method for implementing a passive degassing module within a liquid delivery system.

At a first step 602, a degassing module may be positioned between a liquid source and a recipient. Consider the situation, wherein for example, a degassing module is positioned between a bulk ink source and an ink cartridge. In an embodiment, the degassing module is positioned at the highest point relative to the ink cartridge. By being positioned at the highest point, the degassing module may be positioned to spontaneously collect the gas that may accumulate within the liquid delivery system.

At a next step 604, gas may be accumulated in a first chamber of the degassing module. Unlike the prior art, the degassing module may be configured to handle gas flowing from multi-directions. In an embodiment, the degassing module may be configured to accumulate not only gas that may be inherent within the liquid source the gas that is flowing in the same direction of the liquid), but may also include the gas that may be generated during nucleation (the gas flowing in the counter-flow direction of the liquid).

At a next step 606, gas may be selectively passed through a membrane into a second chamber. In an embodiment, the membrane is a gas permeable membrane that is made from inert materials (e.g., Teflon®, silicone, etc.). In other words, the membrane may be employed to selectively separate gas from the liquid (e.g. ink).

At a next step 608, the gas may be expelled from the second chamber. As gas accumulates within the second chamber, the pressure within the second chamber may increase. Once the pressure level reaches a predetermined maximum level, the one-way air valve may open and the gas within the second chamber may be vented into the external environment. The pressure within the second chamber prevents gas from the external environment from flowing inward. As the gas is vented, the pressure within the second chamber may decrease. Once pressure has reduced to a predetermined minimal level (which is below the predetermined maximum level) within the second chamber, the one-way as valve may be automatically close.

The steps as described in FIG. 6 may be iterative and may be repeated until all liquid has been delivered from the liquid source to the liquid recipient.

As can be appreciated from the foregoing, the degassing module is an inexpensive and passive solution that prevents vapor lock from occurring. By taking advantage of the fundamental law of physic to spontaneously accumulate and expel gas within the BIS system, a non-invasive degassing module may be employed to prevent vapor lock while maintaining the integrity of the closed and balanced environment of the BIS system. With the degassing module, the full cost benefit of the BIS system may be realized

While this invention has been described in terms of several preferred embodiments, there are alterations, permutations, and equivalents which fall within the scope of this invention. For example, given the disclosure, one skilled, in the art can apply many of the techniques to any liquid delivery system. Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A degassing apparatus for a liquid delivery system, comprising:
a first chamber disposed along a liquid delivery path to capture gas within said liquid delivery path;
a set of membranes having at least one membrane, said set of membranes disposed along said liquid delivery path to selectively allow said gas to pass through said set of membranes;
a second chamber disposed above said set of membranes to evacuate said gas from said first chamber; and
a one-way valve configured to vent said gas from said second chamber when pressure inside said second chamber exceeds a first predetermined value.

2. The degassing apparatus of claim 1 wherein said set of membranes is a single gas permeable membrane.

3. The degassing apparatus of claim 2 wherein said single gas permeable membrane is made from inert material.

4. The degassing apparatus of claim 2 wherein said inert material includes Teflon®.

5. The degassing apparatus of claim 2 wherein said inert material includes silicone.

6. The degassing apparatus of claim 1 wherein said set of membranes is positioned between said first chamber and said second chamber.

7. The degassing apparatus of claim 1 wherein said one-way valve is configured to be automatically closed when said pressure within said second chamber falls below a second predetermined value, wherein said second predetermined value is less than said first predetermined value.

8. A liquid delivery system, comprising:
a liquid source;
a liquid recipient;
a set of liquid distribution channels having at least one liquid distribution channel for moving liquid between said liquid source and said liquid recipient; and
a degassing module disposed along said at least one liquid distribution channel of said set of liquid distribution channels, wherein said degassing module including at least
a first chamber disposed along a liquid delivery path of said at least one liquid distribution channel to capture gas within said liquid delivery path,
a set of membranes having at least one membrane, said set of membranes disposed along said liquid delivery path to selectively allow said gas to pass through said set of membranes,
a second chamber disposed above said set of membranes to evacuate said gas from said first chamber, and
a one-way valve configured to vent said gas from said second chamber when pressure inside said second chamber exceeds a first predetermined value.

9. The liquid delivery system of claim 8 wherein said liquid source is ink.

10. The liquid delivery system of claim 8 wherein said liquid recipient is a print cartridge.

11. The liquid delivery system of claim 8 wherein said set of membranes is a single gas permeable membrane.

12. The liquid delivery system of claim 11 wherein said single gas permeable membrane is made from inert material, wherein said inert material including Teflon® and silicone.

13. The liquid delivery system of claim 8 wherein said set of membranes is positioned between said first chamber and said second chamber.

14. The liquid deliver system of claim 8 wherein said one-way valve is configured to be automatically closed when said pressure within said second chamber falls below a second predetermined value, wherein said second predetermined value is less than said first predetermined value.

15. The liquid delivery system of claim 8 wherein said degassing module is positioned at a highest point of said liquid delivery path.

16. A method for degassing in a liquid delivery system, comprising:
providing, a first chamber disposed along a liquid delivery path of said liquid delivery system to capture gas from said liquid delivery system;
providing a second chamber, said second chamber being disposed above said first chamber and separated from said first chamber by a set of membranes having, at least one membrane that is selectively permeable with respect to said gas and selectively impermeable with respect to liquid of said liquid delivery system; and
providing a one-way valve with said second chamber such that said one-way valve opens to vent said gas from said second chamber when pressure within said second chamber exceeds a first pre-determined value.

17. The method of claim 16 wherein said one-way valve is configured to close when said pressure within said second chamber falls below a second predetermined value and wherein said first predetermined value is higher than said second predetermined value.

18. The method of claim 16 wherein said set of membranes includes a set of gas permeable membranes.

19. The method of claim 16 wherein said set of membranes is made from inert material, wherein said inert material includes Teflon® and silicone.

20. The method of claim 16 wherein said first chamber is disposed at a highest point of said liquid delivery path, wherein said highest point is a location where said gas rises to and accumulates within said liquid delivery system.
